(19) United States
(12) Patent Application Publication
(10) Pub. No.: US 2015/0278197 A1
(43) Pub. Date: Oct. 1, 2015

(54) Constructing Comparable Corpora with Universal Similarity Measure

(71) Applicant: ABBYY InfoPoisk LLC, Moscow (RU)

(72) Inventor: Daria Nikolaevna Bogdanova, Moscow (RU)

(21) Appl. No.: 14/668,434

(22) Filed: Mar. 25, 2015

(30) Foreign Application Priority Data
Mar. 31, 2014 (RU) 2014112241

(51) Int. Cl. G06F 17/27

(52) U.S. Cl. CPC G06F 17/2785

(57) ABSTRACT

The invention describes a system and method for creating a comparable corpus by obtaining a set of source documents containing text, constructing language-independent semantic structures for at least one sentence of each of the texts in the source documents; determining universal similarity measures for groups of the source documents by comparing the constructed language-independent semantic structures of the texts in the source documents; identifying sets of similar documents based on the determined universal similarity measures for the groups of the source documents; and creating the comparable corpus based on the identified sets of similar documents.

This application claims the benefit of priority to Russian Patent Application No. 2014112241, filed on Mar. 31, 2014; disclosure of which is incorporated herein by reference in its entirety.

### FIELD OF INVENTION

Implementations of the present invention relate to natural language processing. In particular, implementations of the present invention relate to constructing comparable corpora from texts, in one or more languages. A comparable corpus is a corpus of similar documents in one or more languages. Comparable corpora are used in machine translation as an alternative for the parallel text corpora, because constructing a parallel text corpus is much more expensive than a comparable corpus. In addition, one of the problems of parallel corpus is that it contains translated texts. However, translated text is always “hooked” to the original and can be “non-demonstrative” for the language, in which it is written. Comparing documents may comprise estimation, computation and visualization of measures of similarity between numbers of documents.

### RELATED ART

Many natural language processing tasks require comparing documents in order to find out how similar they are, i.e. computing similarity of the documents. Among such tasks there may be, for example, plagiarism and duplicate or near-duplicate identification. The methods of statistics and machine learning (for example, classification, clustering, etc.) are used for document similarity detection. As a rule, the methods of similarity detection are based on lexical features of the text, such as word, character, expression, phrase, etc. For particular tasks it is also necessary to evaluate the level of similarity. However, if we deal with cross—language documents, the lexical features of the text can be insufficient.

Most of the existing document processing systems are able to deal with documents written only in one or rarely in a few particular languages. The systems are not able to compare documents written in different languages because similarity between such documents cannot be computed properly. Many systems are also limited to particular document formats, cannot analyze documents in different formats and are not able to convert documents to the necessary format during comparison.

Comparable corpus is used in machine translation instead of parallel corpus. The advantage of comparable corpus usage is that comparable texts are independent, while texts in parallel corpus are dependent translations of each other and therefore are not “demonstrative” of the languages which they are written in. The example of comparable corpus is Wikipedia, which contains pages in different languages addressing the same topic and written from scratch, not translated from the source language.

Existing methods of building a corpus of comparable documents is based on the detection of similar documents by matching their topics or subject matters. However, the features of the text used in the process are not sufficient for document similarity detection. The method of present invention solves these problems. This invention disclosure describes the method dealing with documents written in one or more languages and also having the same of different forms and formats.

### SUMMARY

The present invention is related to a method or a system of constructing a comparable corpus, including: creation of a source set of documents, containing texts; construction of a language-independent semantic structures for at least one sentence of each text; determination of a universal similarity measure for groups of these documents by comparing language-independent semantic structures of the texts from these documents; detection of similar documents based on the universal similarity measures of the document groups; construction of the comparable corpus based on the detected similar documents. Source set of documents can be created as a result of a document search by a topic. Furthermore, comparable corpus includes only groups of documents for which the value of their similarity measures exceeds some threshold value. Threshold value can be selected based on a small sets of documents by pair-wise comparison of the documents within the small sets with different threshold values of similarity measure and by determining the best results of such comparisons. The pair-wise comparison follows the step of document preprocessing and converting the documents into machine-readable format, analysis of the texts, contained in the documents, which includes extracting logical structures and block-structures of the texts, and also extracting lexical, semantic and syntactic features of the texts, constructing the best syntactic structures and language-independent semantic structures of the texts. Constructing comparable corpus from the document groups with the values of universal similarity measures exceeding some threshold value, follows the process of filtering the document duplicates.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings.

FIG. 1 is a flow diagram of a method of similarity/difference estimation according to one or more embodiments of the invention.

FIG. 1A is a flow diagram of a method according to one or more embodiments of the invention.

FIG. 2 shows a flow diagram of the method in details according to one or more embodiments of the invention.

FIG. 2A illustrates a graph of generalized constituents of an exemplary sentence according to one or more embodiments of the invention.

FIG. 3 shows an example of a syntactic tree, obtained as a result of a precise syntactic analysis of the sentence.

FIG. 4 shows an example of a semantic structure, obtained for the sentence.

FIG. 5A illustrates fragments of a semantic hierarchy.

FIG. 5B illustrates fragments of a semantic hierarchy.

FIG. 5C illustrates fragments of a semantic hierarchy.

FIG. 5D illustrates fragments of a semantic hierarchy.

FIG. 6 is a diagram illustrating language descriptions according to one or more embodiments of the invention.

FIG. 7 is a diagram illustrating morphological descriptions according to one or more embodiments of the invention.

FIG. 8 is diagram illustrating syntactic descriptions according to one or more embodiments of the invention.

FIG. 9 is diagram illustrating semantic descriptions according to one or more embodiments of the invention.

FIG. 10 is a diagram illustrating lexical descriptions according to one or more embodiments of the invention.

FIG. 11 is an example of visualization of a result of comparing two documents.

FIG. 12 shows a flow diagram of a method of finding similar/different documents within a collection of documents, according to one or more embodiments of the invention.

FIG. 13 is a diagram illustrating the selection of threshold value of universal similarity measure according to one or more embodiments of the invention.

FIG. 14 shows an exemplary hardware for implementing the invention according to one or more embodiments of the invention.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an implementation” means that a particular feature, structure, or characteristic described in connection with the embodiment is included in at least one implementation of the invention. The appearances of the phrase “in one embodiment” or “in one implementation” in various places in the specification are not necessarily all referring to the same embodiment or implementation, nor are separate or alternative embodiments mutually exclusive of other embodiments. Moreover, various features are described which may be exhibited by some embodiments and not by others. Similarly, various requirements are described which may be requirements for some embodiments but not other embodiments.

Implementations of the present invention disclose techniques for comparing documents that could contain different types of information including textual information presented in various languages. We propose a method to estimate similarity between documents with textual information, which can be compared based on exhaustive syntactic and semantic analyses and language-independent semantic structures. Various lexical, grammatical, syntactical, pragmatic, semantic and other features may be identified in text and used to effectively solve said task.

In one or more implementation an estimated universal similarity measure is represented by its value. Additionally, it may be represented with visualization techniques, such as through a graphical user interface (GUI). Document similarity and difference can be defined, for example, as follows:

sim(doc₁, . . . , docₙ)=s(text(doc₁), . . . , text(docₙ)), where n is the number of documents to be compared, text( )—is a function of extracting of textual information from a document, and s( )—the function of comparison of textual information in different documents. In one embodiment, optionally, comparison of documents includes identification of documents' logical structure (for example, described in U.S. Pat. No. 8,260,049 “Model-based method of document logical structure recognition in OCR systems”, filed Sep. 4, 2012). Block structures may be identified before or after optical character recognition of the documents. In such case, further similarity estimation could be stopped if the identified structures are found to be sufficiently different. At first, most important blocks, such as titles or headers, may be compared. In one embodiment, block structures of the documents are compared with some weights, e.g. document header has higher weight and therefore influences final similarity/difference more than other blocks. In another embodiment, if found logical and/or block structures have tree-like view, the comparing may be executed step by step in a top-down approach, and it can be stopped if a sufficient amount of difference or a sufficient number of differences is discovered during some step.

In one embodiment of the invention, similarity can be described as: sim(doc₁, doc₂)=f (doc(Text₁), doc(Text₂))=simₜₑₓₜ(doc₁, doc₂), where do c (Textᵢ)—parts of the documents containing textual information, and f—is some function.

In one embodiment, the mentioned universal similarity measure may be a real-valued, usually non-negative, function of two or more arguments.

Sometimes documents look similar or even identical, even though they include differences. Some differences are not easy to detect or it may take a long time for a person to make a comparison to find out that the documents in question are not identical. Such differences include, for example, using letters from another alphabet which have similar spelling, “masking” spaces with characters, of the same color as the background and thus not visible, inserting additional spaces, presenting some of the text as an image, etc. In this case, an implementation of this invention can be employed to determine a universal measure of document similarity or difference.

A simple way to compare documents with information in different languages is to apply machine translation algorithms to one or more of the sources, which propagate errors due to the imperfect nature of translation. In the current invention, machine translation techniques are not required to be applied to sources, because textual parts of the sources, files or documents are first converted into language-independent semantic structures (LISS).

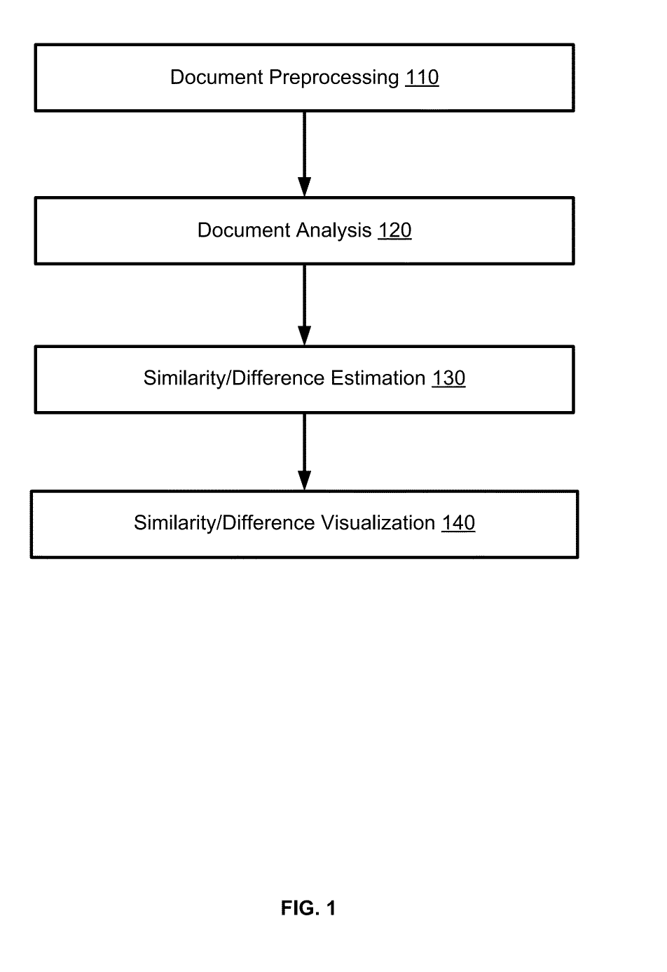

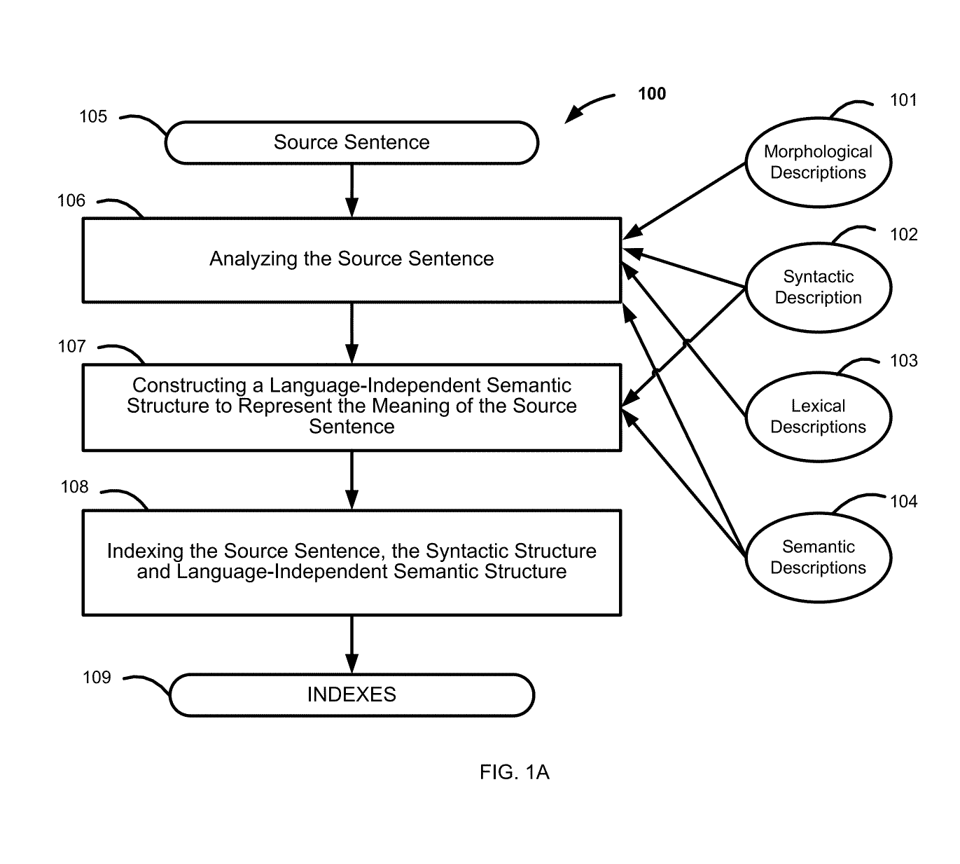

FIG. 1 is a flow diagram of a method of similarity/difference estimation according to one or more embodiments of the invention. First, each document is preprocessed 110. During this step 110, the logical and block structure of each document may be determined, types of blocks are identified, text blocks of the document may be recognized with methods associated with OCR. Preprocessing may be followed by analysis 120 of the documents, e.g., exhaustive syntactic and semantic analyses of text included in the documents. Next, estimating a measure of similarity between documents is performed at step 130. Similarity and/or difference may be represented as real-valued functions of one or more arguments. The arguments may include, but are not limited to, content of documents of various information types including results of said preprocessing step 110. Finally, at step 140 one or more various visualizations may be made illustrating similarities and/or differences. Visualization may be done by showing one or more documents and highlighting, underlining, emphasizing or indicating similar parts and different parts.

For each corresponding text block, the system may employ automatic syntactic and semantic analyses to determine and to extract lexical, grammatical, syntactical, pragmatic, semantic and other features for further use in processing texts. These features are extracted during the process of a substantially exhaustive analysis of each sentence and constructing language-independent semantic structures (LISS), generally one for each sentence processed. Such preliminary exhaustive analysis precedes similarity estimation in one embodiment of the present invention. The system analyzes sentences using linguistic descriptions of a given natural language to reflect real complexities of the natural language, rather than simplified or artificial descriptions. The system functions based on the principle of integral and purpose-driven recognition, where hypotheses about the syntactic structure of a part of a sentence are verified within the hypotheses about the syntactic structure of the whole sentence. It avoids analyzing numerous parsing of anomalous variants. Then, syntactic and semantic information about each sentence is extracted and the results are parsed. Then the lexical choices, including resolving ambiguities are made based on the extracted and parsed semantic and syntactic information. The resulting information and the results may be then indexed and stored.

FIG. 1A is a flow diagram 100 of a method of a substantially exhaustive analysis as detailed herein according to one or more embodiments of the invention. With reference to FIG. 1A, linguistic descriptions may include, at least, lexical descriptions 103, morphological descriptions 101, syntactic descriptions 102, and semantic descriptions 104. The method includes starting from a source sentence 105. The source sentence is analyzed 106 (as described more fully herein). Next, a language-independent semantic structure (LISS) is constructed 107. The LISS represents the meaning of the source sentence. Next, the source sentence, the syntactic structure of the source sentence and the LISS are indexed 108. The result is a set of collection of indexes or indices 109.

An index usually comprises a representation in the form of a table where each value of a feature (e.g., word, sentence, parameter, etc.) in a document is accompanied by a list of numbers or addresses of its occurrences in that document. For example, for each feature found in the text (e.g., word, character, expression, and phrase) an index includes a list of sentences where it was found, and the word's place in the sentence. For instance, if the word “dog” was found in a text in the 1st sentence at the 4th place, and also in the 2nd sentence at the 2nd place, in the 10th—at the 4th and in 22nd sentences at the 5th place, its index may approximately looks like “dog”—(1.4), (2.2), (10.4), (22.5). The number of the sentence is not necessary; one can just number all the words from the beginning of the text.

If an index is created for a corpora, i.e., a set of texts, it may include a number corresponding to one of the texts that belong to the corpora. Similarly, indexes of other features of the sentences, are revealed during the analysis 106, e.g., semantic classes, semantemes, grammemes, syntactic relations, semantic relations etc. According to some embodiments of the present invention, morphological, syntactic, lexical, and semantic features can be indexed in the same fashion as each word in a document. In one embodiment of the present invention, indexes may be produced to index all or at least one value of morphological, syntactic, lexical, and semantic features (parameters) for each sentence or other portion of the text. These parameters or values are generated during the two-step semantic analysis described below. The index may be used to facilitate natural language processing.

In one implementation, said linguistic descriptions include a plurality of linguistic models and knowledge about natural languages. These data may be arranged in a database and used for analyzing each text or source sentences such as at step 106. Such a plurality of linguistic models may include, but is not limited to, morphological models, syntax models, grammar models and lexical-semantic models. In a particular implementation, integral models for describing the syntax and semantics of a language are used in order to recognize the meanings of the source sentence, analyze complex language structures, and correctly convey information encoded in the source sentence.

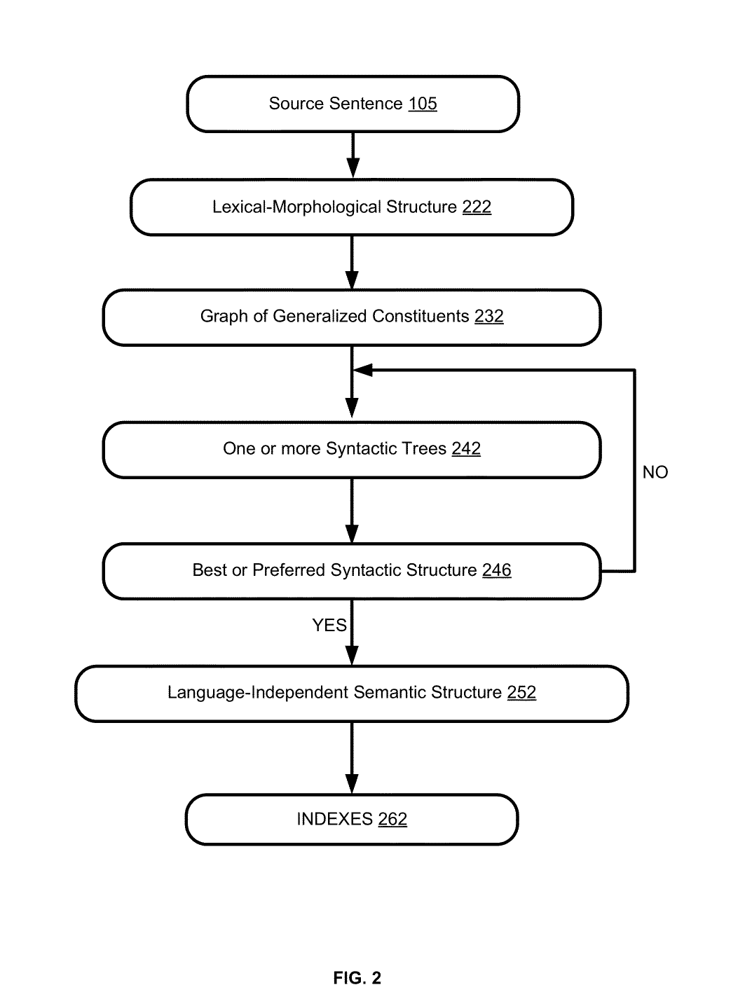

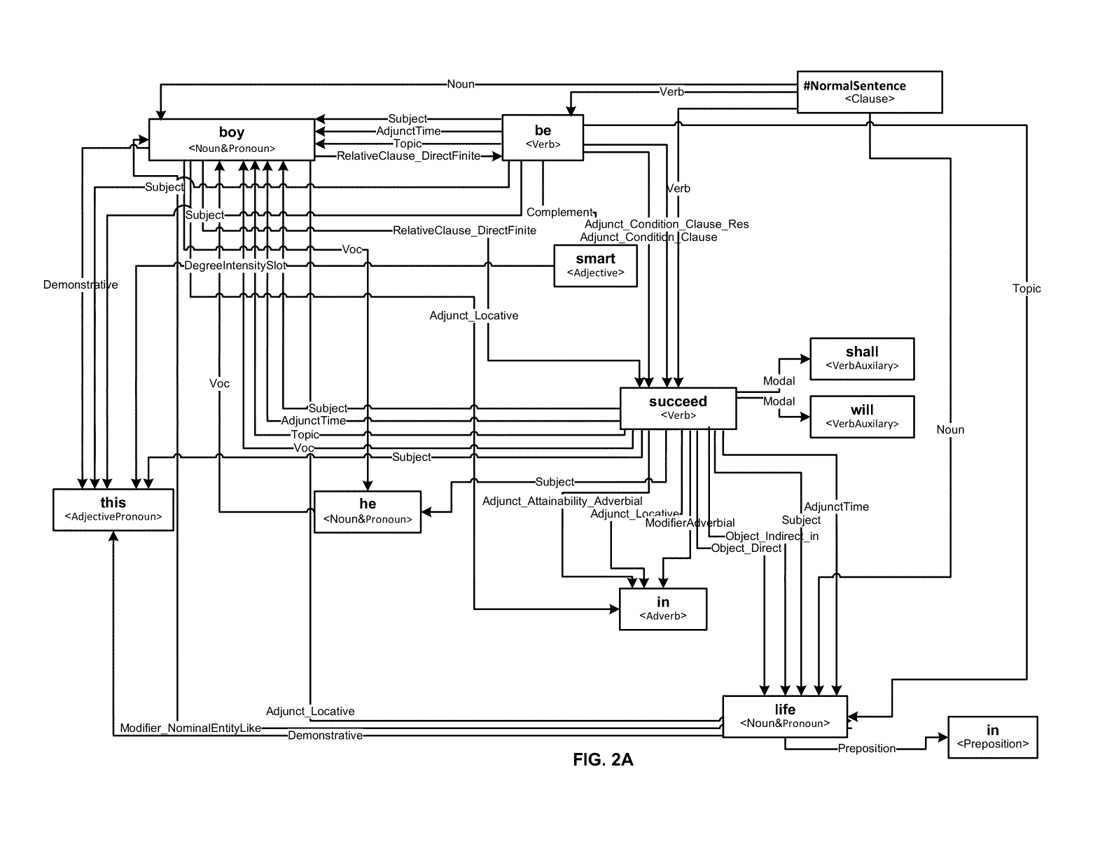

With reference to FIG. 1A and FIG. 2, when analyzing 106 the meaning of the source sentence 105, a lexical-morphological structure 222 is identified. Next, a syntactic analysis is performed and is realized in a two-step analysis algorithm (e.g., a “rough” syntactic analysis and a “precise” syntactic analysis) implemented to make use of linguistic models and knowledge at various levels, to calculate probability ratings and to generate the most probable syntactic structure, e.g., a best syntactic structure.

Accordingly, a rough syntactic analysis is performed on the source sentence to generate a graph of generalized constituents 232 for further syntactic analysis. All reasonably possible surface syntactic models for each element of lexical-morphological structure are applied, and all the possible constituents are built and generalized to represent all the possible variants of parsing the sentence syntactically. FIG. 2A illustrates a graph of generalized constituents of an exemplary sentence, “This boy is smart, he′ll succeed in life” according to one exemplary embodiment of the invention.

Following the rough syntactic analysis, a precise syntactic analysis is performed on the graph of generalized constituents to generate one or more syntactic trees 242 to represent the source sentence. In one implementation, generating the syntactic tree 242 comprises choosing between lexical options and between relations from the graphs. Many prior and statistical ratings may be used during the process of choosing between lexical options, and in choosing between relations from the graph. The prior and statistical ratings may also be used for assessment of parts of the generated tree and for the whole tree. In one implementation, the one or more syntactic trees may be generated or arranged in order of decreasing assessment. Thus, the best syntactic tree may be generated first. Non-tree links are also checked and generated for each syntactic tree at this time. If the first generated syntactic tree fails, for example, because of an impossibility to establish non-tree links, the second syntactic tree is taken as the best, etc.

Many lexical, grammatical, syntactical, pragmatic, semantic features are extracted during the steps of analysis. For example, the system can extract and store lexical information and information about belonging lexical items to semantic classes, information about grammatical forms and linear order, about syntactic relations and surface slots, using predefined forms, aspects, sentiment features such as positive-negative relations, deep slots, non-tree links, semantemes, etc.

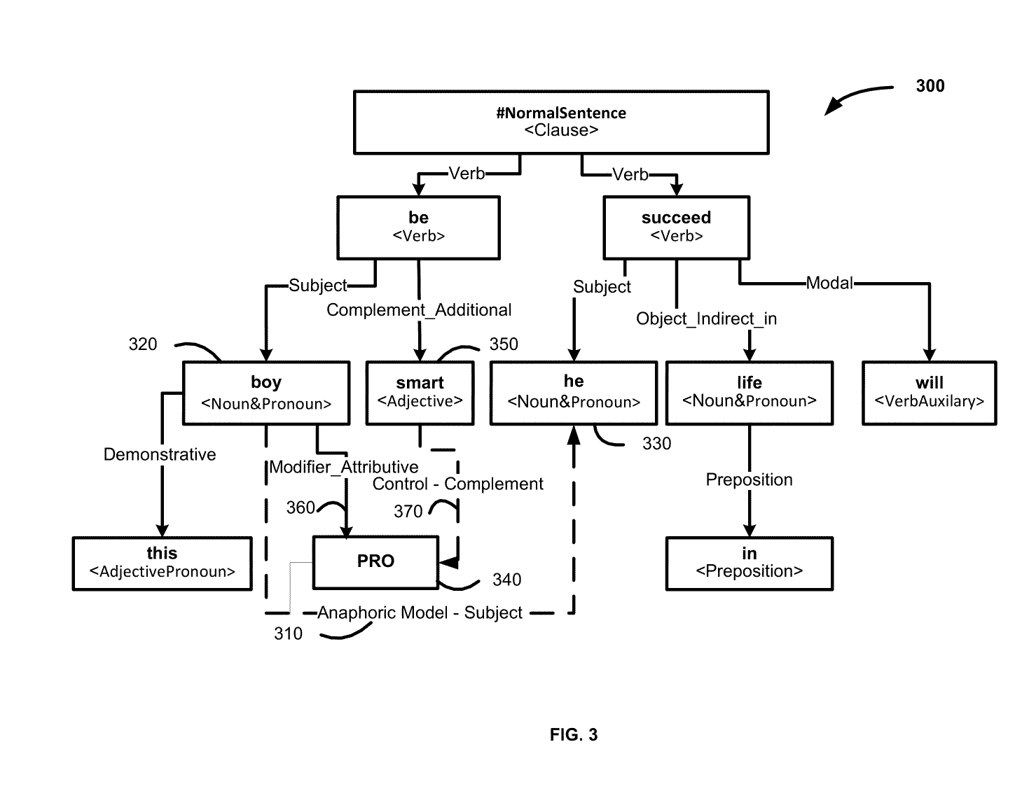

FIG. 3 shows an example of a syntactic tree 300, obtained as a result of a precise syntactic analysis of the sentence, “This boy is smart, he′ll succeed in life.” This tree contains complete or substantially complete syntactic information, such as lexical meanings, parts of speech, syntactic roles, grammatical values, syntactic relations (slots), syntactic models, non-tree link types, etc. For example, “he” is found to relate to “boy” as an anaphoric model subject 310. “Boy” is found as a subject 320 of the verb “be.” “He” is found to be the subject 330 of “succeed.” “Smart” is found to relate to “boy” through a “control—complement” 340. “Smart” is found to be an adjective 350.

With reference to FIG. 2, this two-step syntactic analysis approach ensures that the meaning of the source sentence is accurately represented by the best syntactic structure 246 chosen from the one or more syntactic trees. Advantageously, the two-step analysis approach follows a principle of integral and purpose-driven recognition, i.e., hypotheses about the structure of a part of a sentence are verified using all available linguistic descriptions within the hypotheses about the structure of the whole sentence. This approach avoids a need to analyze numerous parsing anomalies or variants known to be invalid. In some situations, this approach reduces the computational resources required to process the sentence.

With reference again to FIG. 1A, after the sentence has been analyzed, at step 107 the syntactic structure of the sentence is semantically interpreted, and a language-independent semantic structure is constructed to represent the meaning of the sentence. The language-independent semantic structure is a generalized data structure in a language-independent form or format. Such language-independent semantic structure or LISS is generated for each sentence to accurately describe the meaning of the sentence and to reflect all or substantially all grammatical, lexical and syntactic features in language-independent terms. The LISS is an effective means to compare disparate sources of information with one another.

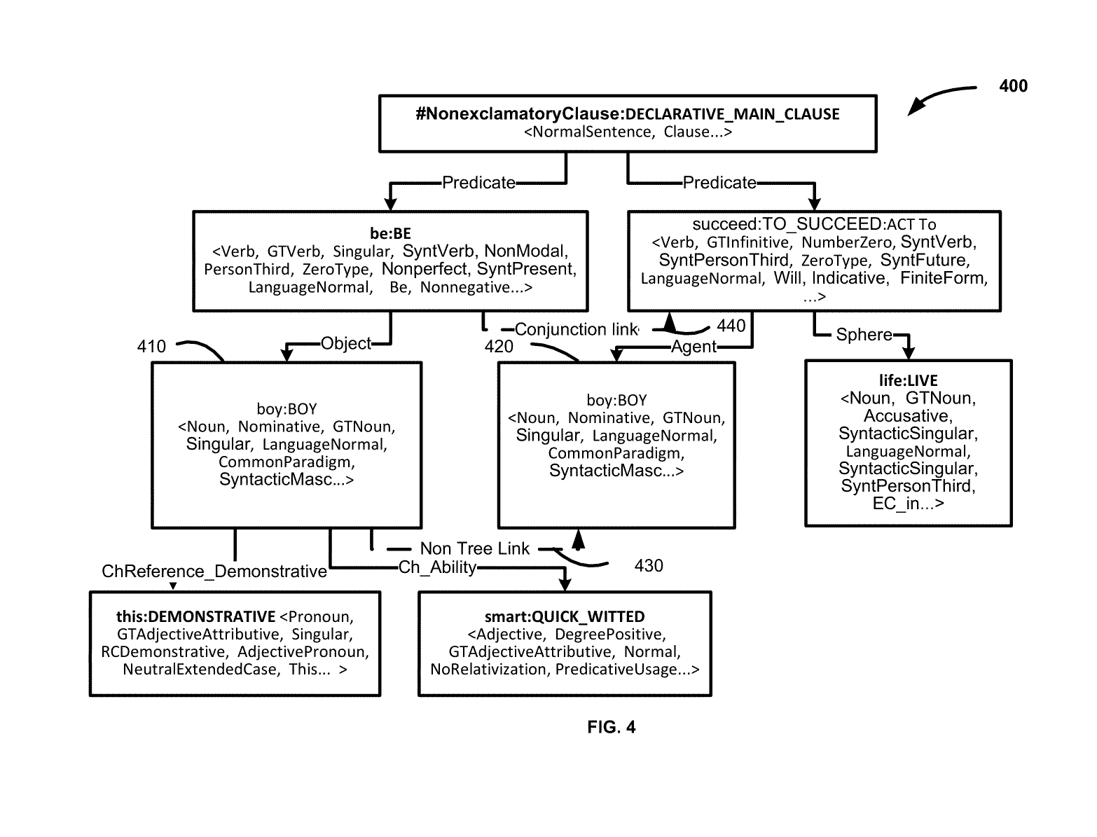

The analysis methods ensure that the maximum accuracy in conveying or understanding the meaning of the sentence is achieved. FIG. 4 shows an example of a semantic structure, obtained for the sentence “This boy is smart, he′ll succeed in life.” With reference to FIG. 4, this structure contains all syntactic and semantic information, such as semantic class, semantemes, semantic relations (deep slots), non-tree links, etc.

With reference to FIG. 4, the conjunction non-tree link 440 connects two parts of the complex sentence “This boy is smart, he′ll succeed in life.” Also, referential non-tree link 430 connects two constituents 410 and 420. This non-tree link reflects anaphoric relation between the words “boy” and “he” to identify the subjects of the two parts of the complex sentence. This relation (310) is also shown on a syntactic tree (FIG. 3) after a syntactic analysis and establishing non-tree links. Additionally, a proform PRO 340 is inserted to establish a link between the controller (“boy”) 320 and the controlled element (“smart”) 350. As a result, the complement “smart” 350 fills the surface slot “Modifier_Attributive” 360 of the controller “boy” 320 by means of a link of type “Control-Complement” 370.

Referring to FIG. 2, illustrated therein is a method to convert a source sentence 105 into a language independent semantic structure (LISS) 252 through the use of various structures according to an exemplary implementation of the invention and the linguistic descriptions employed. With reference to FIG. 2, a lexical-morphological structure 222 is found or created from a sentence (each sentence in a corpora or multi-sentence text). A graph of generalized constituents is created 232. Next, one or more syntactic trees are created 242. A best or preferred syntactic structure is selected 246. If the best one is not found, the method iterates until the best syntactic structure is identified (or until the possibilities have been exhausted). Indices of syntactic features may be generated after this step of selecting the best syntactic structure 246. Once the best syntactic structure is identified and selected 246, a language-independent semantic structure is created 252. After this step of generating the language-independent semantic structure or LISS is completed, indexes 262 of semantic and other features (lexical, syntactical, morphological, pragmatic, etc.) which had been recognized during all steps of the analysis, may be generated.

The language-independent semantic structure of a sentence is represented as an acyclic graph (a tree supplemented with non-tree links) where all words of specific language are substituted with their universal (language-independent) semantic notions or semantic entities referred to herein as “semantic classes”. Semantic class is one of the most important semantic features that can be extracted and used for tasks of classifying, clustering and filtering text documents written in one or many languages. The other features usable for such task may be semantemes because they may reflect not only semantic, but also syntactical, grammatical, and other language-specific features in language-independent structures.

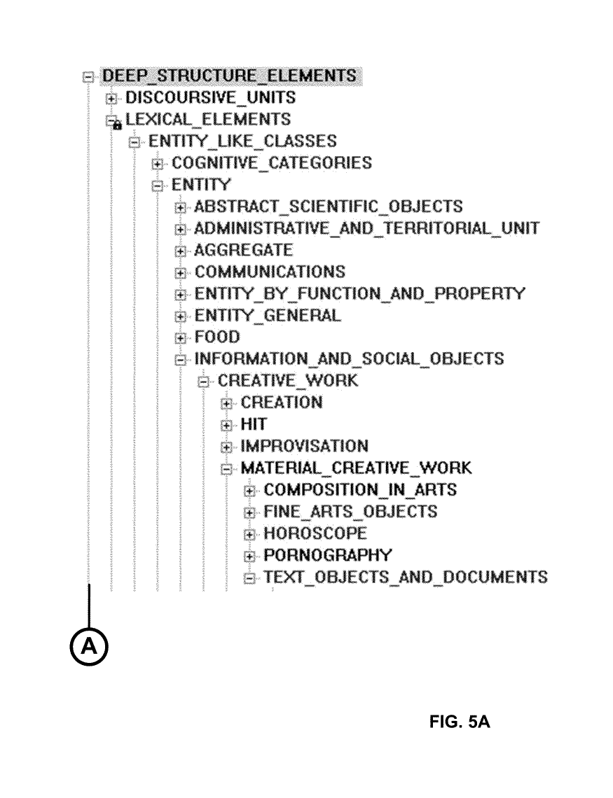

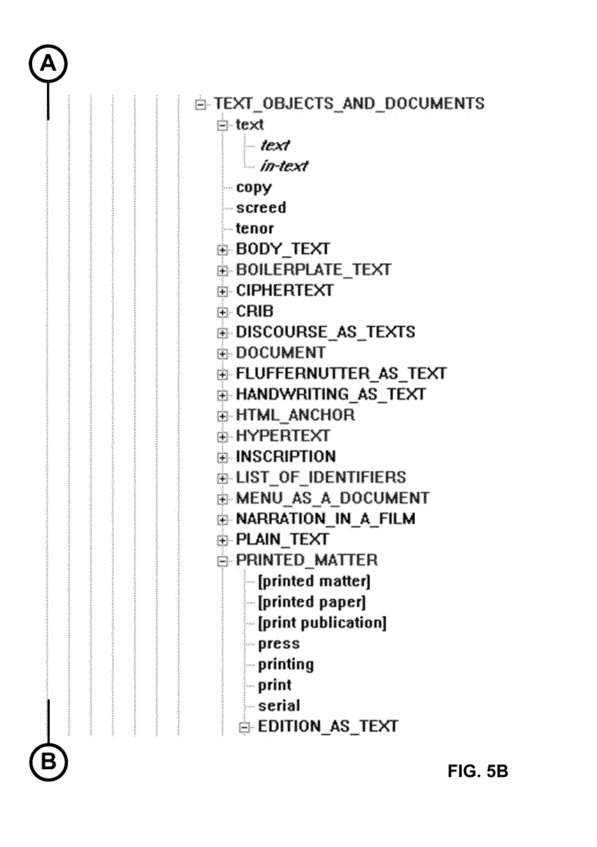

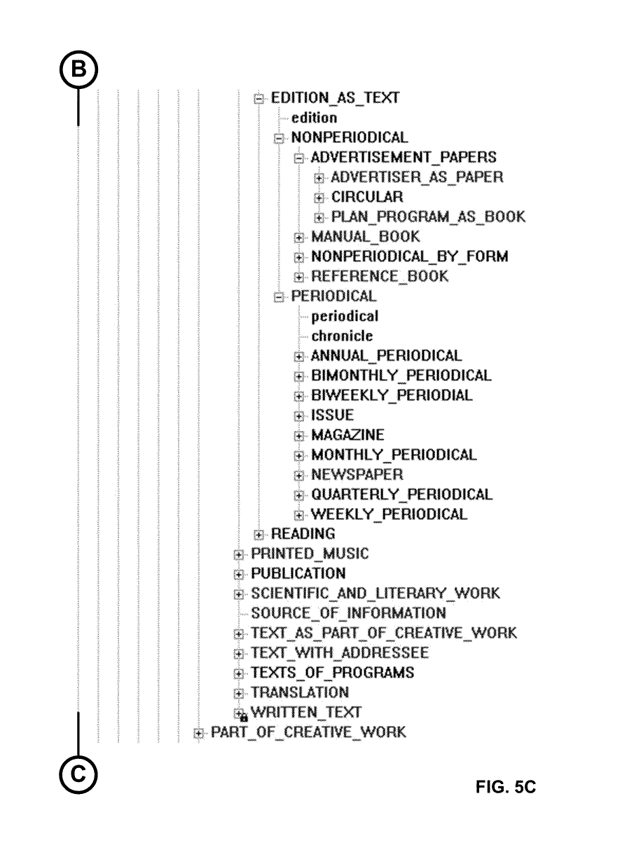

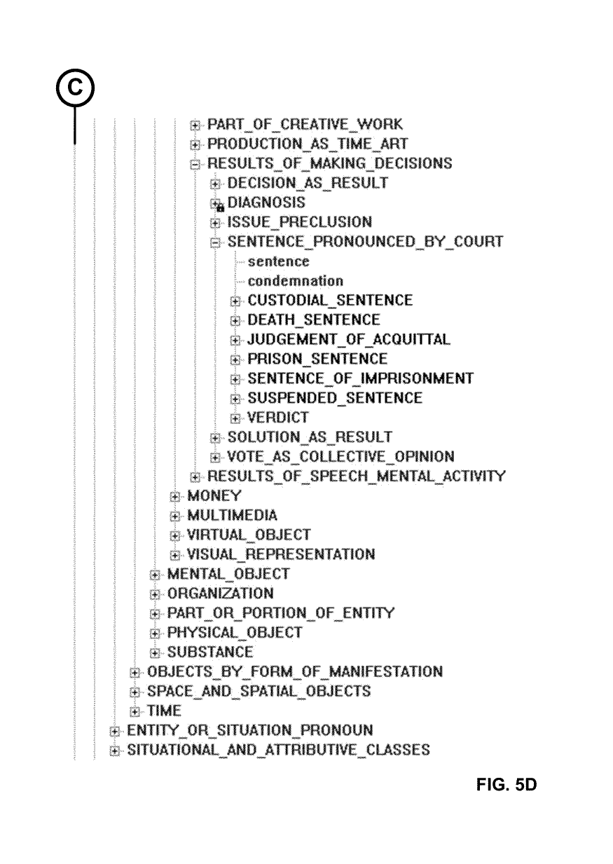

The semantic classes, as part of linguistic descriptions, are arranged into a semantic hierarchy comprising hierarchical parent-child relationships. In general, a child semantic class inherits many or most properties of its direct parent and all ancestral semantic classes. For example, semantic class SUBSTANCE is a child of semantic class ENTITY and at the same time it is a parent of semantic classes GAS, LIQUID, METAL, WOOD_MATERIAL, etc. FIGS. 5A-5D illustrate fragments of said semantic hierarchy.

Each semantic class in the semantic hierarchy is supplied with a deep model. The deep model of the semantic class is a set of deep slots. Deep slots reflect the semantic roles of child constituents in various sentences with objects of the semantic class as the core of a parent constituent and the possible semantic classes as fillers of deep slots. The deep slots express semantic relationships between constituents, including, for example, “agent”, “addressee”, “instrument”, “quantity”, etc. A child semantic class inherits and adjusts the deep model of its direct parent semantic class.

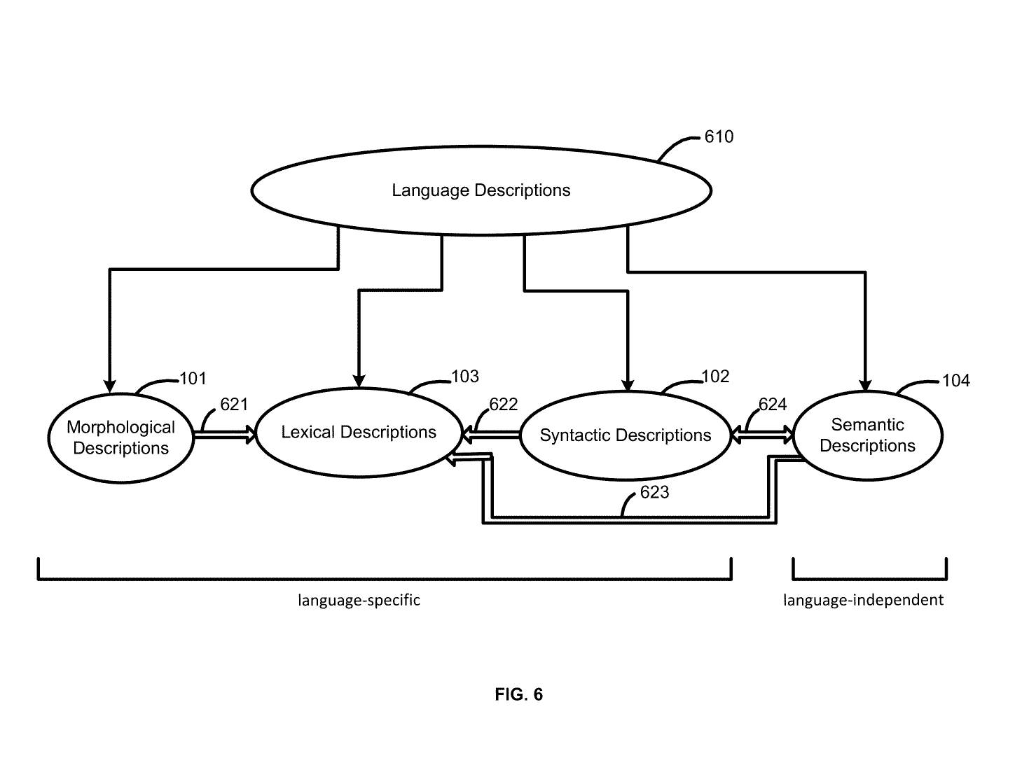

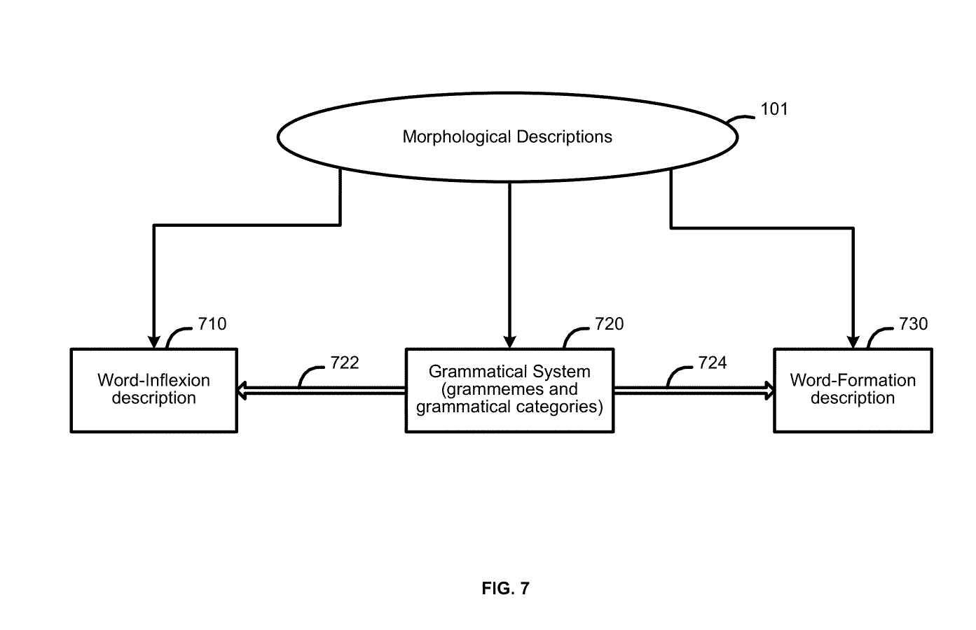

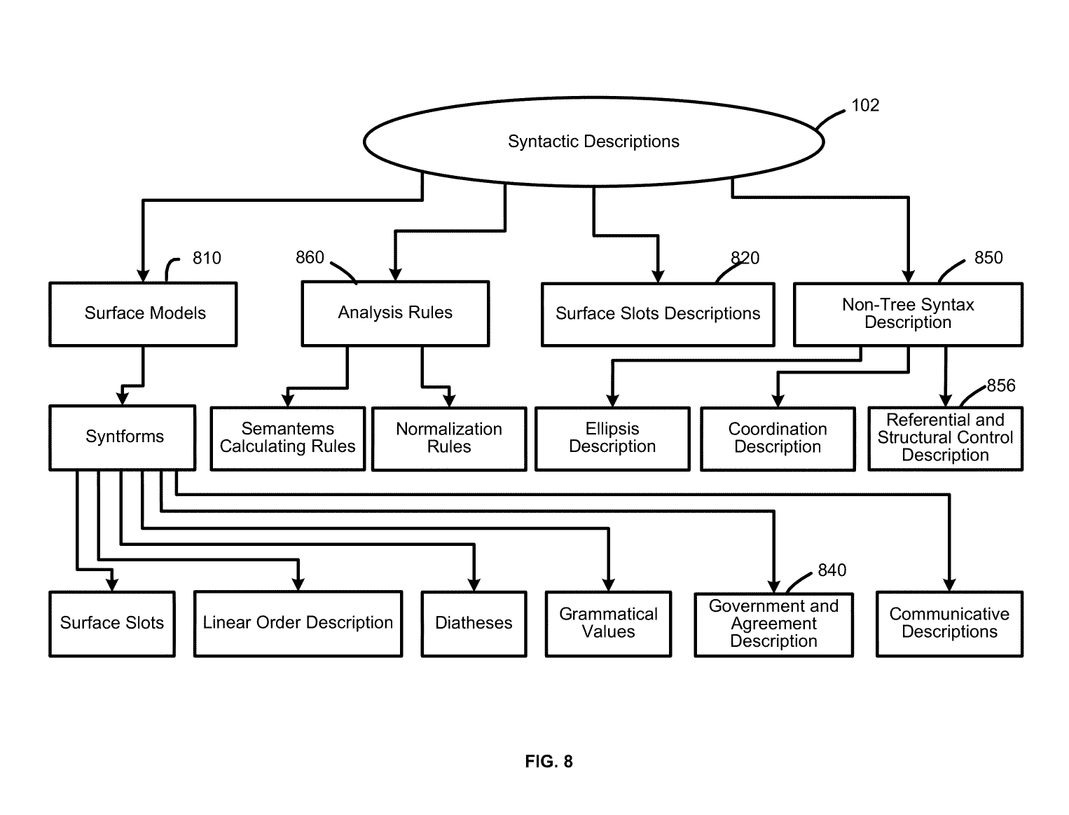

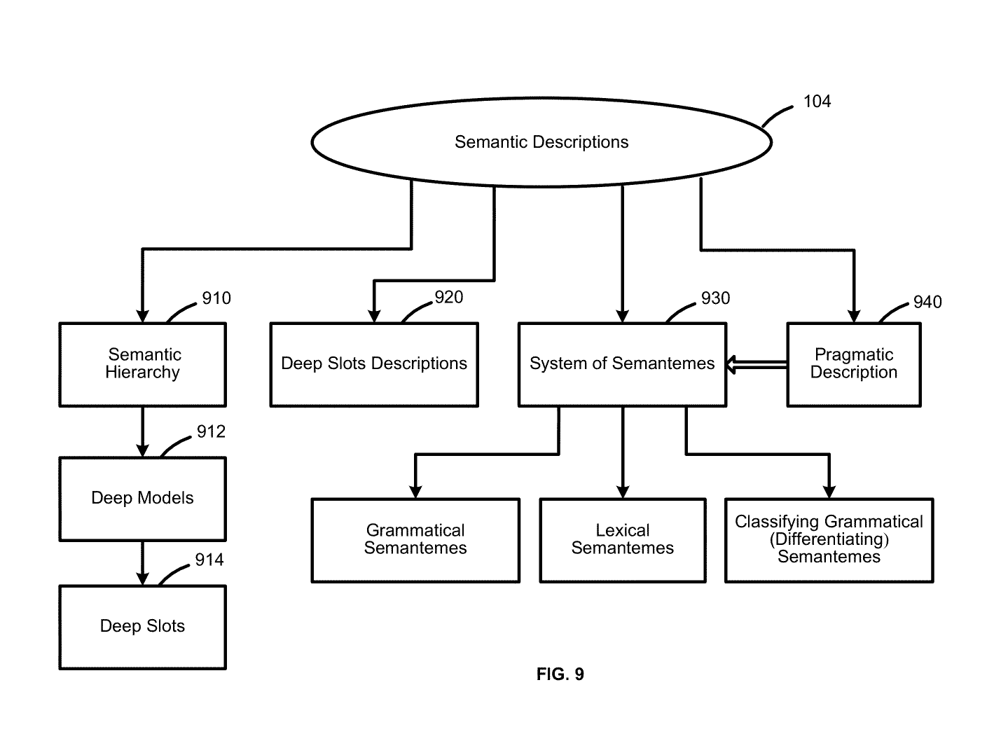

FIG. 6 is a diagram illustrating language descriptions 610 according to one exemplary implementation of the invention. With reference to FIG. 6, language descriptions 610 comprise morphological descriptions 101, syntactic descriptions 102, lexical descriptions, 103 and semantic descriptions 104. FIG. 7 is a diagram illustrating morphological descriptions according to one or more embodiments of the invention. FIG. 8 is a diagram illustrating syntactic descriptions according to one or more embodiments of the invention. FIG. 9 is diagram illustrating semantic descriptions according to one or more embodiments of the invention.

With reference to FIG. 6 and FIG. 9, being a part of semantic descriptions 104, the semantic hierarchy 910 is a core feature of the language descriptions 610, which links together language-independent semantic descriptions 104 and language-specific, lexical descriptions 103 as shown by the double arrow 623. It also is linked to morphological descriptions 101 and syntactic descriptions 102 as shown by the double arrows 621, 622, and 624. A semantic hierarchy may be created just once, and then may be filled for each specific language. Semantic class in a specific language includes lexical meanings with their models. Semantic descriptions 104 are language-independent. Semantic descriptions 104 may provide descriptions of deep constituents, and may comprise a semantic hierarchy, deep slots descriptions, a system of semantemes, and pragmatic descriptions.

With reference to FIG. 6, the morphological descriptions 101, the lexical descriptions 103, the syntactic descriptions 102, and the semantic descriptions 104 may be related. A lexical meaning may have one or more surface (syntactic) models that may be provided by semantemes and pragmatic characteristics. The syntactic descriptions 102 and the semantic descriptions 104 are also related. For example, diatheses of the syntactic descriptions 102 can be considered as an “interface” between the language-specific surface models and language-independent deep models of the semantic description 104.

FIG. 7 illustrates exemplary morphological descriptions 101. As shown, the components of the morphological descriptions 101 include, but are not limited to, word-inflexion description 710, grammatical system (e.g., grammemes) 720, and word-formation description 730. In one embodiment, grammatical system 720 includes a set of grammatical categories, such as, “Part of speech”, “Case”, “Gender”, “Number”, “Person”, “Reflexivity”, “Tense”, “Aspect”, etc. and their meanings, hereafter referred to as “grammemes”. For example, part of speech grammemes may include “Adjective”, “Noun”, “Verb”, etc.; case grammemes may include “Nominative”, “Accusative”, “Genitive”, etc.; and gender grammemes may include “Feminine”, “Masculine”, “Neuter”, etc.

With reference to FIG. 7, a word-inflexion description 710 describes how the main form of a word may change according to its case, gender, number, tense, etc. and broadly includes all possible forms for a given word. Word-formation 730 describes which new words may be generated involving a given word. The grammemes are units of the grammatical systems 720 and, as shown by a link 722 and a link 724, the grammemes can be used to build the word-inflexion description 710 and the word-formation description 730.

FIG. 8 illustrates exemplary syntactic descriptions 102. With reference to FIG. 8, the components of the syntactic descriptions 102 may comprise surface models 810, surface slot descriptions 820, referential and structural control descriptions 856, government and agreement descriptions 840, non-tree syntax descriptions 850, and analysis rules 860. The syntactic descriptions 102 are used to construct possible syntactic structures of a sentence from a given source language, taking into account free linear word order, non-tree syntactic phenomena (e.g., coordination, ellipsis, etc.), referential relationships, and other considerations.

FIG. 9 shows an example of semantic descriptions 104 according to an illustrative embodiment. While the surface slots descriptions 820 reflect the syntactic relationships and means to implement them in a specific language, deep slots 914 reflect the semantic role of child (dependent) constituents in deep models 912. Therefore, descriptions of surface slots, and more broadly surface models, can be specific for each actual language. The deep slot descriptions 920 contain grammatical and semantic limitations on items that can fill these slots. The properties and limitations for deep slots 914 and the items that fill them in deep models 912 are often similar or identical for different languages.

The system of semantemes 930 represents a set of semantic categories. Semantemes may reflect lexical and grammatical categories and attributes as well as differential properties and stylistic, pragmatic and communication characteristics. For example, the semantic category “DegreeOfComparison” may be used to describe degrees of comparison expressed in different forms of adjectives, such as “easy,” “easier”, and “easiest.” Accordingly, the semantic category “DegreeOfComparison” may include semantemes such as “Positive,” “ComparativeHigherDegree,” and “SuperlativeHighestDegree.” Another example is semantic category “RelationToReferencepoint”, which can be used for describing the linear order of the incident and link on it in the sentence, its semantems are “Previous” and “Subsequent”. Semantic category “EvaluationObjective” can set the presence of objective evaluation, such as “Bad”, “Good”. Lexical semantemes may describe specific properties of objects such as “being flat” or “being liquid”, and may be used in limitations on items for filling deep slots. Classifications of grammatical (differentiating) semantemes are used to express differential properties within a single semantic class.

Pragmatic descriptions 940 serve to establish an appropriate theme, style or genre for the text during the analysis process, and it is also possible to ascribe the corresponding characteristics to objects in a Semantic Hierarchy. For example, pragmatic descriptions may be used to describe themes such as “Economic Policy”, “Foreign Policy”, “Justice”, “Legislation”, “Trade”, “Finance”, etc.

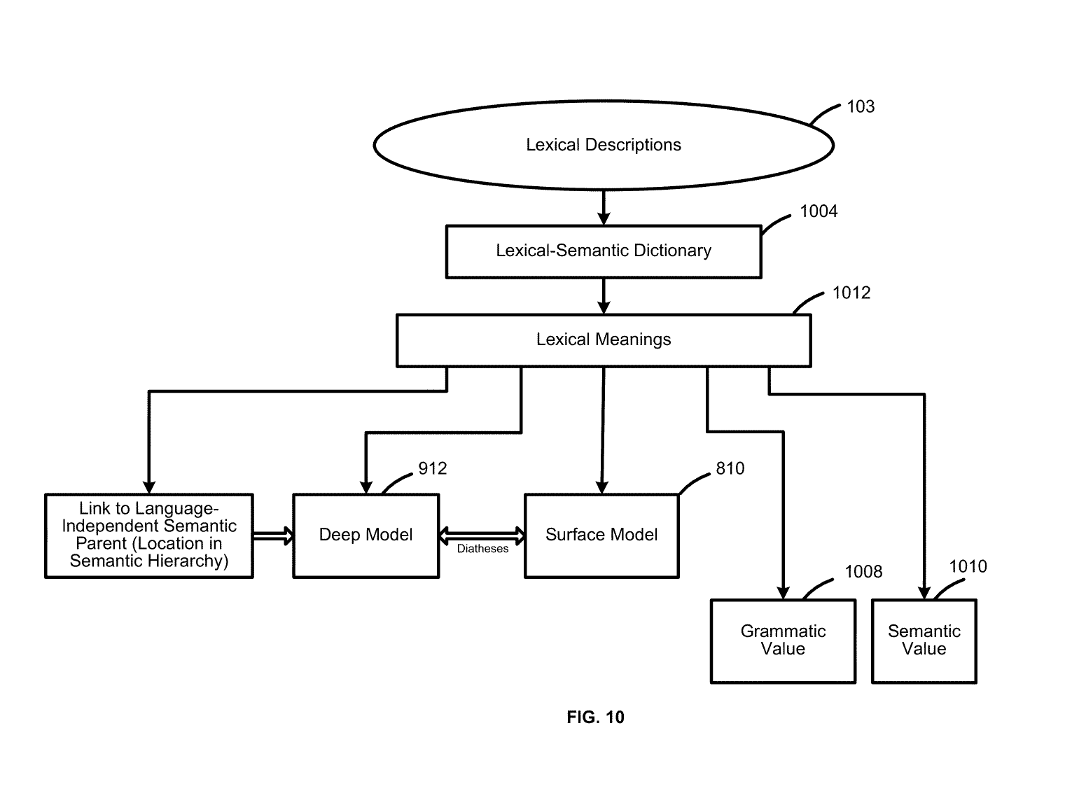

FIG. 10 is a diagram illustrating lexical descriptions 103 according to one exemplary implementation of the technology. The lexical descriptions 103 include a lexical-semantic dictionary 1004 that includes a set of lexical meanings 1012 arranged with their semantic classes into a semantic hierarchy, where each lexical meaning may include, but is not limited to, its deep model 912, surface model 810, grammatical value 1008 and semantic value 1010. A lexical meaning may unite different derivates (words) which express the meaning via different parts of speech or different word forms, such as words having the same root. In turn, a semantic class unites lexical meanings of one or more different languages with very close semantics.

Also, any element of language description 610 may be extracted during a substantially exhaustive analysis of texts, may be indexed (the index for the feature are created), the indices may be stored and used for the task of classifying, clustering and filtering text documents written in one or many languages. In one implementation, indexing of semantic classes is most significant and helpful for solving these tasks. Syntactic structures and semantic structures also may be indexed and stored for using in semantic searching, classifying, clustering and filtering.

One simple way to estimate similarity between two texts in the same language is to compare their indexes. It may be indexes of words, or indexes of semantic classes. The indexes may be presented by simple data structures, for example, arrays of numbers. If indexes of words for texts are identical, then the texts are identical, or may be considered identical for a particular purpose. If indexes of semantic classes for two texts are identical, then the texts are identical or substantially similar. This approach of using indexes of semantic classes, with some limitations, also may be applied to estimating similarity of texts in different languages. A word order in corresponding sentences in different languages may be different, so when estimating universal similarity measure for two sentences, it is acceptable to ignore the number of a word in the sentence corresponding to its placement or word order.

Another problem is that the most frequent words in a language, such as “the”, “not”, “and” etc. usually are not indexed, so the two sentences, “The approval of the CEO is required” and “The approval of the CEO isn't required” will have the same indexes, and these two sentences will be identified as the same by conventional methods. The methods of the present invention identify the sentences as different because they also take into account specific lexical, syntactical and semantic features extracted during steps of the analysis. The fact that the verb “require” is presented in negative form in one of the sentences is fixed by means of semantemes.

But, a problem arises if, for example, in some cases, one sentence in a language corresponds two or more sentences in another language and vice versa. In this case, to increase the accuracy of the present methods, the techniques of aligning (for example, presented in U.S. application Ser. No. 13/464,447, “Method and System for Alignment of Parallel Text Corpora”, filed May 22, 2012) of two or more texts may be applied before indexing. There are many ways to calculate similarity between two texts. One simple way to find out if two texts are similar is to count how many words they have in common. There are also more advanced versions of this approach such as techniques involving lemmatization, stemming, weighting, etc. For example, a vector space model (G. Salton, 1975) may be built, and vector similarity measures, such as e.g. cosine similarity, may be utilized.

During the text processing described here, documents may be represented with language independent semantic classes that in their turn may be considered as lexical features. Therefore, the similarity measures as were mentioned above may exist.

Such similarity measures have a drawback in that they do not actually capture the semantics. For example, the two sentences, “Bob has a spaniel” and “Richard owns a dog” are semantically similar but they do not share any words except an article. Therefore, a mere lexical text similarity measure will fail to find that these sentences are similar. To capture this type of similarity, knowledge-based semantic similarity measures may be used. They require a semantic hierarchy to be calculated. Similarity between two words usually depends on a shortest path between corresponding concepts in a corresponding semantic hierarchy. For example, “spaniel” in the semantic hierarchy corresponding to the first sentence above appears as a child node (hyponym) of “dog”, therefore semantic similarity between the concepts will be high. Word-to-word similarity measures may be generalized to text-to-text similarities by combining values for similarities of each word pair. Semantic classes described here represent nodes of semantic hierarchy. Therefore, knowledge-based semantic similarity measures described above and their generalizations to text-to-text similarity measures may be utilized within document processing.

For example, referring to the present invention, textual information may be represented as a list of features, which may include semantic classes {C1, C2, . . . Cm}, semantic features {M1, M2, . . . Mn}, and syntactic features {S1, S2, . . . Sk}. Since lexical meanings may be expressed in different words, and semantic class may unite several close lexical meanings, the semantic class embodies the idea of generalization. Synonyms and derivates are generalized. If we deal with texts in different languages, semantic class generalizes lexical meanings in the different languages. Semantic features reflect semantic structure of a text, which contains semantic roles of elements, such as agent (animated initiator and controller of an action), experiencer (someone who originates feelings and perceptions), etc. Syntactic features reflect syntactic structure of a text, produced, for example, by constituency or dependency parsers.

In the present invention semantic classes are organized into the semantic hierarchy, which is in general a graph. Therefore, in one embodiment, the distance between two nodes can be defined as the shortest path between these nodes in the graph. And similarity the distance between semantic classes can be a function of the mentioned distance between them.

In another embodiment, the universal similarity measure for two or more documents may be defined heuristically or on the basis of experience. For example, we have 2 text documents —D1 and D2. After semantic analysis we have two sets of semantic classes C(D1)={C11, C12, . . . C1n} and C(D2)={C21, C22, . . . C2m}. Each class may be supplied by coefficient of the frequency Fij in the document. Most frequent semantic classes in the language may be discarded. Most common semantic classes (like ENTITY, ABSRACT SCIENTIFIC OBJECT, etc.) also may be discarded. Then universal similarity or difference measure depends on the distances between each pair of semantic classes (C1, C2), where C1εC(D1) and C2εC(D2). In one embodiment, the universal similarity or difference measure between semantic classes may be defined as, for example, a function of the path between semantic classes, i.e., sim(C1, C2)=f(path(C1, C2)), dif(C1, C2)=g(path(C1, C2)), e.g. identity function. In another embodiment, the universal similarity measure or the universal difference measure is based on the idea of the closest common ancestor of the classes: anc(C1, C2).

In one embodiment, the similarity between texts may be defined as follows:

$$sim ( {D}_{1} , {D}_{2} ) = g ( \frac{{\sum }_{C 1 ∈ C ( D 1 ) , C 2 ∈ C ( D 2 )} sim ( C 1 , C 2 )}{\vert C ( {D}_{1} ) \vert \cdot \vert C ( {D}_{2} ) \vert} )$$

where |C(D)| denotes the number of semantic classes in C (D), and g is a function.

In one embodiment, the universal difference measure between texts may be defined as follows:

$$dif ( {D}_{1} , {D}_{2} ) = g ( \frac{{\sum }_{C 1 ∈ C ( D 1 ) , C 2 ∈ C ( D 2 )} dif ( C 1 , C 2 )}{\vert C ( {D}_{1} ) \vert \cdot \vert C ( {D}_{2} ) \vert} )$$

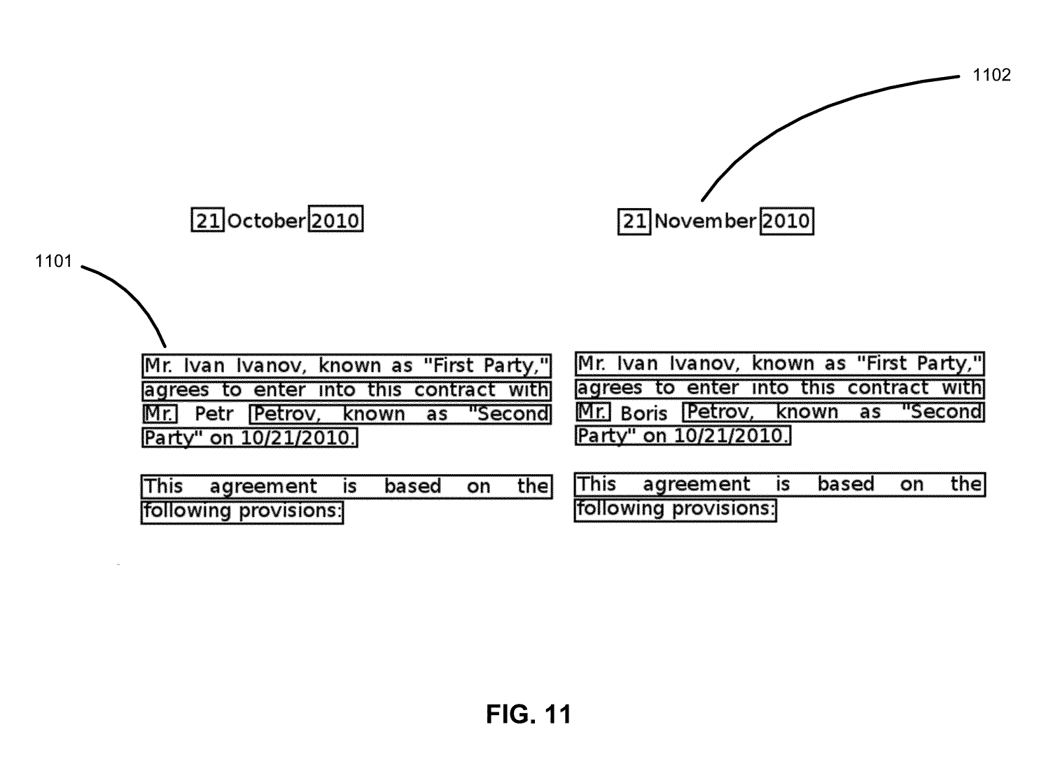

FIG. 11 shows an example of a possible visualization of similarity estimation where identical parts of documents 1101 are accentuated (in frames) and differences 1102 are shown as ordinary text (FIG. 11). Other exemplary methods of visualization include changing the color, size, font, etc. of the words that are the same as those of another document or, alternatively, changing the color, size, font, etc. of the words that are different from the other document. While the form of displaying differences or similarities may vary, embodiments as described herein include showing differences or similarities for the benefit of a viewer or a user.

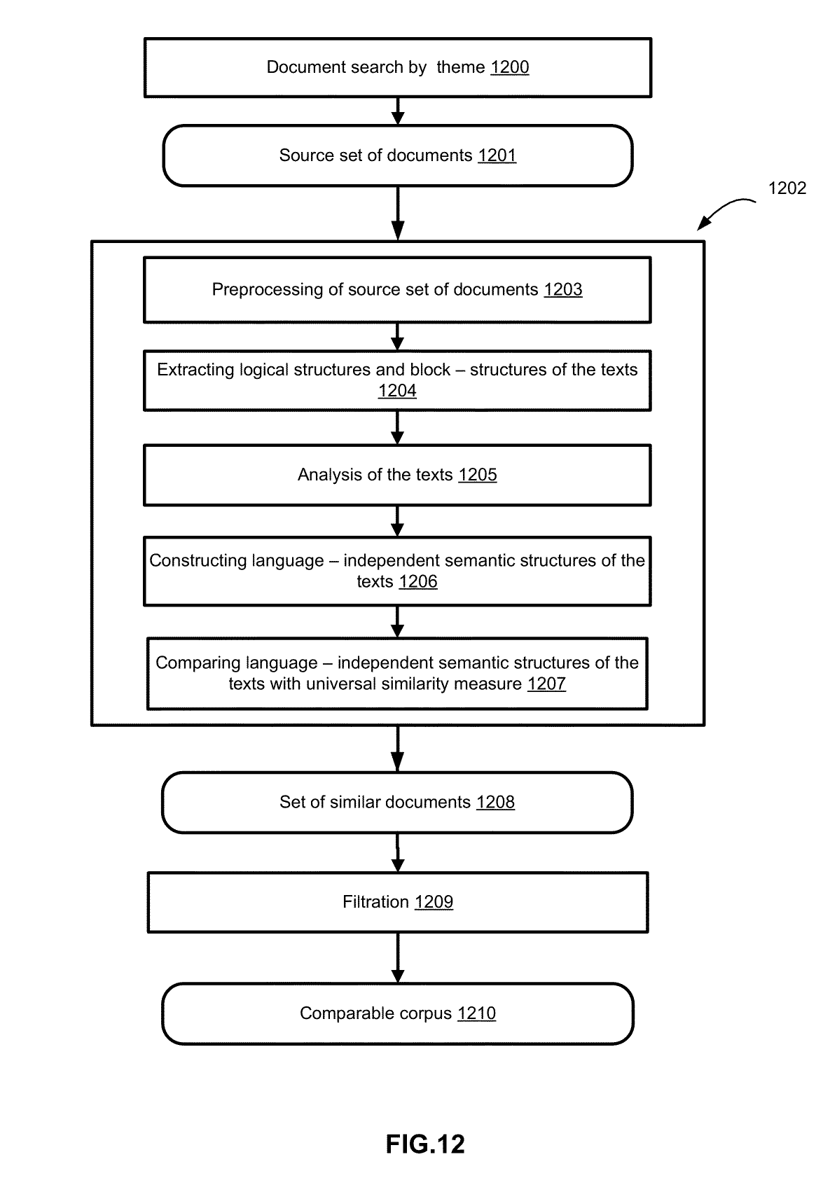

FIG. 12 shows a flow diagram of a method of finding similar documents within a collection of documents, according to one embodiment of the invention. The disclosed notion of similarity, in one embodiment, is applied to analyze various collections of documents (for example, the results of internet search) and construct corpus of comparable documents. With reference to FIG. 12 for compiling source set of documents 1201 one can conduct document search 1200 by topic. After that in source set 1201 the search for similar documents 1202 is implemented. This search can comprise: document preprocessing 1203 (for example, transferring document into machine-readable format); extracting document logical structures, block structures 1204; performing analysis of the texts 1205, which includes computing lexical, semantic, syntactic and other features of the text; constructing language independent semantic structures of the texts 1206; comparing semantic structures of the texts with universal similarity measure 1207; and estimating similarity between documents, containing correspondent texts. After finishing the comparison between documents with universal similarity measure, we obtain set of similar documents 1208. This set includes pairs (or bigger sets) of documents with the value of the universal similarity measure equal or above a threshold value. Then, the filtration 1209 of duplicate or near—duplicate documents in terms of universal similarity measure is implemented. For example, if we have a text in Russian R1 and two texts in English E1 and E2, for which universal similarity measure of R1 and E1 is sim(R1, E1)=a, and universal similarity measure of R1 and E2 is sim(R1, E2)=b, where a and b exceed the threshold value of the universal similarity measure, then the text with higher value of universal similarity measure will be added to the corpus. As a result, the comparable corpus 1210 is created.

The building of universal similarity measure 1206 can be rather long and resource-intensive, that's why some methods of fastening this process may be used. For example, one can construct language-independent semantic structure not for the whole text, but for it's most important parts and compare them.

The threshold value of similarity measure, which should be reached before the text is added to the comparable corpus, can be defined empirically. Only semantically-close texts in different languages are added to the corpus. If the set includes duplicate texts or very similar documents in the same language, than only one of the duplicates of similar documents is added to the corpus. The exact method of defining the threshold value may depend on the given task. In one embodiment, for determining the threshold value of the similarity measure, the “evaluation in vivo” method can be utilized (i.e., identifying the threshold value in reference to the overall goal). Since the comparable corpus is usually utilized for the training of machine translation systems, we can take a number of document sets of small sizes and compare documents within each of them with different values of universal similarity measure (if the threshold value of universal similarity measure possesses the value between 0 and 1, then one can select the value with measurement pitch of 0.1), and make some experiments with compared documents. Based on the results of the experiments we can select the best threshold value of universal similarity measure and construct the comparable corpus with universal similarity measure of this particular value. In another embodiment, we can select the threshold value of similarity measure manually and then manually determine whether the selected value is the best for our goal.

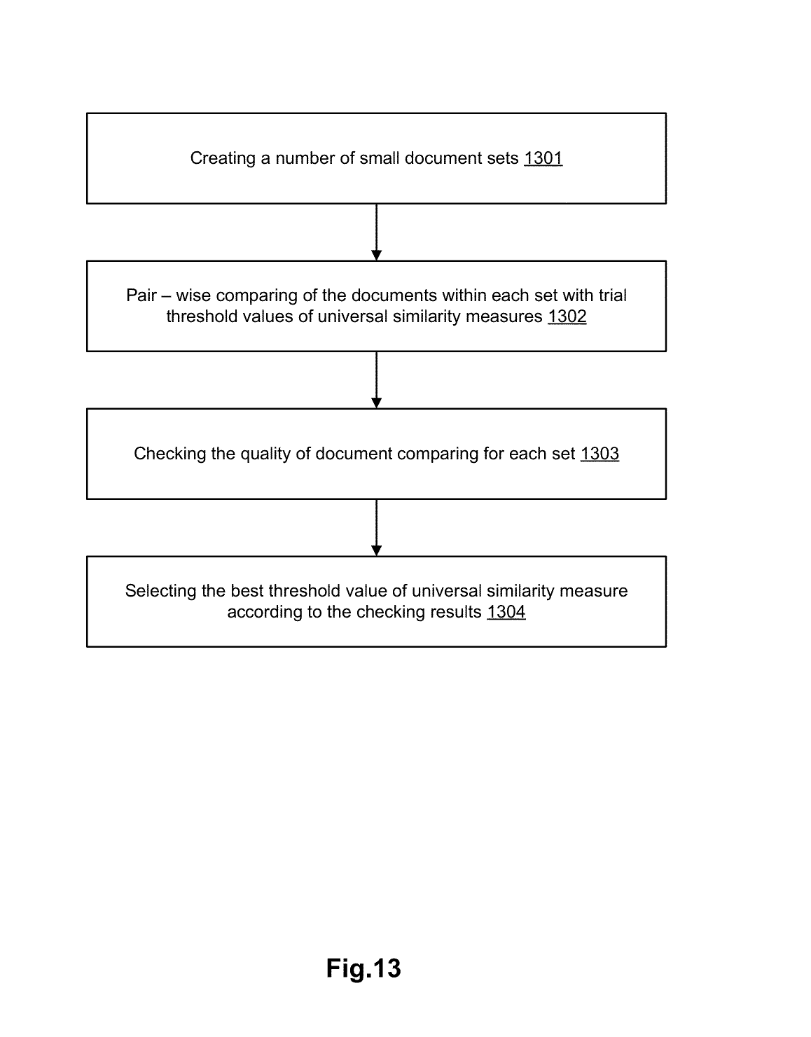

FIG. 13 illustrates the main steps of the method for choosing the threshold value of the universal similarity measure. At first, the number of small document sets is created 1301. Then within each collection pair-wise comparing of the documents is performed with the trial threshold values of similarity measure 1302. The trial threshold values differ from each other on the magnitude of the measurement pitch. The step of obtaining several collections of compared documents 1302 is followed by the checking step 1303. Based on the results of the checking step one can choose the best threshold value of the universal similarity measure 1304 and proceed with constructing the corpus 1210 with chosen threshold value of universal similarity measure.

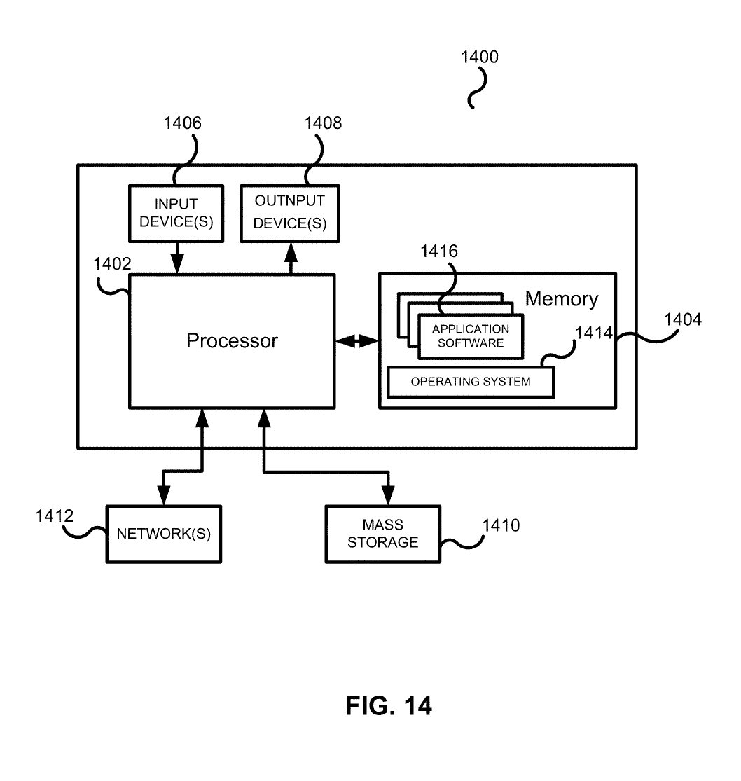

FIG. 14 shows exemplary hardware for implementing the techniques and systems described herein, in accordance with one implementation of the present disclosure. The exemplary hardware 1400 includes at least one processor 1402 coupled to a memory 1404. The processor 1402 may represent one or more processors (e.g. microprocessors), and the memory 1404 may represent random access memory (RAM) devices comprising a main storage of the hardware 1400, as well as any supplemental levels of memory, e.g., cache memories, non-volatile or back-up memories (e.g. programmable or flash memories), read-only memories, etc. In addition, the memory 1404 may be considered to include memory storage physically located elsewhere in the hardware 1400, e.g. any cache memory in the processor 1402 as well as any storage capacity used as a virtual memory, e.g., as stored on a mass storage device 1410.

The hardware 1400 also typically receives a number of inputs and outputs for communicating information externally. For interface with a user or operator, the hardware 1400 may include one or more user input devices 1406 (e.g., a keyboard, a mouse, imaging device, scanner, microphone) and a one or more output devices 1408 (e.g., a Liquid Crystal Display (LCD) panel, a sound playback device (speaker)). To embody the present invention, the hardware 1400 typically includes at least one screen device. For additional storage, the hardware 1400 may also include one or more mass storage devices 1410, e.g., a floppy or other removable disk drive, a hard disk drive, a Direct Access Storage Device (DASD), an optical drive (e.g. a Compact Disk (CD) drive, a Digital Versatile Disk (DVD) drive) and/or a tape drive, among others. Furthermore, the hardware 1400 may include an interface with one or more networks 1412 (e.g., a local area network (LAN), a wide area network (WAN), a wireless network, and/or the Internet among others) to permit the communication of information with other computers coupled to the networks. It should be appreciated that the hardware 1400 typically includes suitable analog and/or digital interfaces between the processor 1402 and each of the components 1404, 1406, 1408, and 1412 as is well known in the art.

The hardware 1400 operates under the control of an operating system 1414, and executes various computer software applications, components, programs, objects, modules, etc. to implement the techniques described above. Moreover, various applications, components, programs, objects, etc., collectively indicated by application software 1416.

In general, the routines executed to implement the embodiments of the invention may be implemented as part of an operating system or a specific application, component, program, object, module or sequence of instructions referred to as a “computer program.”

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modified or re-arranged in one or more of its details as facilitated by enabling technological advancements without departing from the principals of the present disclosure.

1. A method for creating a comparable corpus, comprising:
obtaining by a computing device a set of source documents containing text;
constructing language-independent semantic structures for at least one sentence of each of the texts in the source documents;
determining by a computing device universal similarity measures for groups of the source documents by comparing the constructed language-independent semantic structures of the texts in the source documents;
identifying by a computing device sets of similar documents based on the determined universal similarity measures for the groups of the source documents;
creating by a computing device the comparable corpus based on the identified sets of similar documents.

2. The method of claim 1, wherein the identifying of the sets of similar documents further comprises comparing the universal similarity measures for the groups of the source documents with a threshold value of the universal similarity measure.

3. The method of claim 1, further comprising:
creating the set of source document by searching for documents on a particular topic.

4. The method of claim 1, further comprising:
preprocessing of the texts in the source documents; and
extracting logical structure and block-structures of the texts in the source documents.

5. The method of claim 1, further comprising
filtering similar documents.

6. A non-transitory computer storage media encoded with one or more computer programs, the one or more computer programs comprising instructions that when executed by data processing apparatus cause the data processing apparatus to perform operations for creating a comparable corpus, comprising:
obtaining by a computing device a set of source documents containing text;
constructing by a computing device language-independent semantic structures for at least one sentence of each of the texts in the source documents;
determining by a computing device universal similarity measures for groups of the source documents by comparing the constructed language-independent semantic structures of the texts in the source documents;
identifying by a computing device sets of similar documents based on the determined universal similarity measures for the groups of the source documents;
creating by a computing device the comparable corpus based on the identified sets of similar documents.

7. The non-transitory computer storage media of claim 6, wherein the identifying of the sets of similar documents further comprises comparing the universal similarity measures for the groups of the source documents with a threshold value of the universal similarity measure.

8. The non-transitory computer storage media of claim 6, further comprising:
creating the set of source document by searching for documents on a particular topic.

9. The non-transitory computer storage media of claim 6, further comprising:
preprocessing of the texts in the source documents; and
extracting logical structure and block-structures of the texts in the source documents.

10. The non-transitory computer storage media of claim 6, further comprising filtering similar documents.

11. A system, comprising:
a memory;
a processing device, coupled to the memory, the processing device configured to:
obtain by a computing device a set of source documents containing text;
construct by a computing device language-independent semantic structures for at least one sentence of each of the texts in the source documents;
determine by a computing device universal similarity measures for groups of the source documents by comparing the constructed language-independent semantic structures of the texts in the source documents;
identify by a computing device sets of similar documents based on the determined universal similarity measures for the groups of the source documents; create by a computing device the comparable corpus based on the identified sets of similar documents.

12. The system of claim 11, wherein the identifying of the sets of similar documents further comprises comparing the universal similarity measures for the groups of the source documents with a threshold value of the universal similarity measure.

13. The system of claim 11, further comprising:
creating the set of source document by searching for documents on a particular topic.

14. The system of claim 11, further comprising:
preprocessing of the texts in the source documents; and
extracting logical structure and block-structures of the texts in the source documents.

15. The system of claim 11, further comprising
filtering similar documents.
